(19) United States
(12) Patent Application Publication
(10) Pub. No.: US 2026/0341618 A1
(43) Pub. Date: Oct. 29, 2026

(54) Reed Relay

(71) Applicant: XIAMEN HONGFA SIGNAL ELECTRONICS CO., LTD., Xiamen, Fujian (CN)

(72) Inventors: Lichao CAO, Xiamen, Fujian (CN); Jiabin LIN, Xiamen, Fujian (CN); Xinshang DONG, Xiamen, Fujian (CN); Fuda NIE, Xiamen, Fujian (CN); Qiming MAO, Xiamen, Fujian (CN)

(21) Appl. No.: 19/116,956

(22) PCT Filed: Sep. 19, 2023
(86) PCT No.: PCT/CN2023/119790

§ 371 Date: Mar. 28, 2025

(30) Foreign Application Priority Data
Sep. 29, 2022 (CN) 202211197856.3
Sep. 29, 2022 (CN) 202211197883.0
Sep. 29, 2022 (CN) 202211201243.2

(51) Int. Cl. H01H 50/44; H01H 50/02; H01H 50/12

(52) U.S. Cl. CPC H01H 50/443; H01H 50/02; H01H 50/12

(57) ABSTRACT

A reed relay includes a reed switch including a glass tube having a circular tube body and a bobbin including a winding portion and two head portions. Wherein a sintered section is provided at each of two ends of the tube body, two contact reeds capable of contacting or separating from each other are provided inside the tube body, and two contact reed leading-out pins respectively pass out of two sintered sections. The bobbin is injection-molded and entirely wraps the glass tube, one ends of two contact reed leading-out pins pass out from a central position of an end surface of each of two head portions. Each sintered section is located in one head portion, a part of each contact reed leading-out pin is covered and fixed by the head portion, each head portion is provided with a coil heat dissipation structure close to the sintered section.

### CROSS REFERENCE TO RELATED APPLICATIONS

The present disclosure is a national stage of International PCT Application No. PCT/CN 2023/119790, filed on Sep. 19, 2023, which claims priority to claims priority to Chinese Patent Application No. 202211197883.0, No. 202211197856.3, and No. 202211201243.2, filed on Sep. 29, 2022, the entire contents of which are incorporated herein by reference.

### TECHNICAL FIELD

The present disclosure relates to a field of reed relay manufacturing technology and, more particularly, to a reed relay.

### BACKGROUND

A reed relay is a derivative based on reed switch technology. Due to a special encapsulation structure (hermetical sintering of a glass tube) and encapsulation process (filling inert gas or vacuum treatment inside the glass tube) of a reed switch, a reed part of the reed switch can be free from being polluted and corroded by the external atmospheric environment, and thus have incomparably high contact reliability and excellent insulation performance. In the field of pursuing high insulation and high contact reliability (represented by instrument testing, network communication, new energy insulation detection, and medical electronics), reed relays have been widely recognized and applied.

A reed relay in the related art typically includes a reed switch, a bobbin, a coil, and a housing. During manufacturing of the reed relay, the bobbin is generally made first, then a glass tube of the reed switch is mounted in a center hole of the bobbin and then fixed by potting. Firstly, this fixing method of the glass tube of the reed switch and the bobbin may easily damage the glass tube of the reed switch, affecting the initial sealing performance of the glass tube of the reed switch, and hindering automatic production. Secondly, due to the use of glue encapsulation, low-molecular-weight substances may be easily separated out, degrading the insulation performance of the reed switch, and a cavity may be easily formed inside the glue, an outer surface of the glue is prone to bulging, which will affect the quality of connection between the reed switch and the bobbin and the insulation performance after connection. Furthermore, the above fixing method of the glass tube of the reed switch and the bobbin is difficult to make the glass tube of the reed switch centrally disposed in the central hole of the bobbin, and is difficult to realize that a center of a contact of a contact reed of the reed switch (where an air gap is the largest) coincides with a window center of the bobbin (where magnetic flux of the coil is the densest), which cannot further improve the electrical performance.

### SUMMARY

A reed relay of the present disclosure includes a reed switch and a bobbin. The reed switch includes a glass tube having a circular tube body. A sintered section is provided at each of two ends of the tube body, two contact reeds capable of contacting or separating from each other are provided inside the tube body, and two contact reed leading-out pins respectively pass out of the two sintered sections along a central axis of the tube body. The bobbin is injection-molded and entirely wraps the glass tube, the bobbin includes a circular tubular winding portion and two head portions connected to two ends of the winding portion, and an end of each of the two contact reed leading-out pins passes out from a central position of an end surface of each of the two head portions. Each sintered section is partially or entirely located in one head portion, a part of each contact reed leading-out pin is covered and fixed by the one head portion, and each head portion is provided with a coil heat dissipation structure close to the sintered section.

According to an embodiment of the present disclosure, the two contact reed leading-out pins respectively pass out of the two sintered sections along the central axis of the tube body.

According to an embodiment of the present disclosure, a central axis of the head portions of the bobbin coincide with a central axis of the winding portion. Thus, it is beneficial to realizing that a center of a contact of the contact reed of the reed switch (where an air gap is the largest) coincides with a center of the wing window of the bobbin (where magnetic flux of the coil is the densest), which cannot only make full use of the magnetic flux of the coil, but also improve consistency of electrical parameters and further improve the electrical performance.

According to an embodiment of the present disclosure, a central axis of the circular tubular winding portion coincides with the central axis of the tube body.

According to an embodiment of the present disclosure, the coil heat dissipation structure includes a plurality of heat dissipation grooves on opposite end surfaces of the two head portions, the plurality of heat dissipation grooves are distributed around a cylindrical surface, and a central axis of the cylindrical surface coincides with the central axis of the tube body.

According to an embodiment of the present disclosure, each head portion further has a plurality of side surfaces connected to the end surface, one end of each heat dissipation groove extends to the side surfaces of the head portion, and another end of each heat dissipation groove is located on the cylindrical surface.

According to an embodiment of the present disclosure, one coil leading-out pin passes through an upper part of each head portion, and an end of each of two coil leading-out pins is electrically connected to a corresponding one of two ends of an enameled wire of the coil.

According to an embodiment of the present disclosure, each of the two head portions is provided with a positioning groove, two positioning grooves of the two head portions are located at a same side of the winding portion, another end of each coil leading-out pin is partially located in the positioning groove after being bent.

According to an embodiment of the present disclosure, each head portion is provided with a wire passing groove close to an end of the coil leading-out pin; and at least one of the head portions is provided with a winding clamping groove.

The wire passing groove can prevent a leading-out wire from moving on the head portion of the bobbin and breaking, and the wire passing groove can protect the leading-out wire. The winding clamping groove facilitates positioning of the winding on the bobbin.

According to an embodiment of the present disclosure, a shape of a cross-sectional profile of each head portion along a direction perpendicular to the central axis of the tube body includes a first rectangle and a second rectangle disposed in a middle of an upper surface of the first rectangle, and a size of the second rectangle is smaller than a size of the first rectangle in the direction perpendicular to the central axis of the tube body.

According to an embodiment of the present disclosure, each contact reed leading-out pin passing out of the head portion is cylindrical, a middle part of each contact reed leading-out pin passing out of the head portion is provided with a flat portion, and the flat portion is parallel to or perpendicular to a contact surface of a contact of the contact reed.

Since the flat portion is provided in the middle part of the contact reed leading-out pin, on the one hand, the contact reed leading-out pin can be more firmly connected to the housing, and on the other hand, an orientation of the contact surface of the contact of the contact reed can be identified more conveniently, facilitating the set-up of a working orientation of the contact surface of the contact, and enhancing the action reliability and the anti-disturbance performance. In addition, the flat portion can be used for positioning when the bobbin is formed by injection molding, and at the same time, the flat portion facilitates the assembly or machining of the housing in a subsequent process.

According to an embodiment of the present disclosure, an injection molding process portion is provided on one of the two head portions and is located at a central position of the end surface of the head portion away from the winding portion. The plastic flows along axial and radial directions of the glass tube during injection. The use of a single injection port to inject plastic laterally can reduce an injection molding pressure, lowering a scouring force of plastic on the glass tube and meanwhile ensure that the plastic in the sintered section flows approximately in the radial direction, so as to ensure, to the greatest extent, that expansion of the plastic matches expansion of the glass (an expansion amount in a plastic flow direction is smaller than in a direction vertical to the flow direction and is closer to the expansion amount of the glass), and plastic flow directions of the sintered sections at the two ends are consistent, thereby better protecting the glass tube of the reed switch, and improving the yield of the injection-molded bobbin.

### BRIEF DESCRIPTION OF THE DRAWINGS

The above and other features and advantages of the present disclosure will become more apparent by describing in detail exemplary embodiments thereof with reference to the accompanying drawings.

FIG. 1 is a perspective view of a reed switch in the related art;

FIG. 2 is a structural schematic view of the reed switch of FIG. 1;

FIG. 3 is a perspective view of a reed relay according to a first embodiment of the present disclosure;

FIG. 4 is a top view of FIG. 3;

FIG. 5 is a sectional view taken along line A-A in FIG. 4;

FIG. 6 is a schematic view illustrating an injection molding process portion and a plastic flow direction during injection molding of a bobbin;

FIG. 7 is a perspective view of a reed relay according to a second embodiment of the present disclosure;

FIG. 8 is a top view of FIG. 7;

FIG. 9 is a sectional view taken along line B-B in FIG. 8;

FIG. 10 is a perspective view of a reed switch connected with a bobbin according to the second embodiment of the present disclosure;

FIG. 11 is a schematic view of a state of connection with a PCB according to the second embodiment of the present disclosure;

FIG. 12 is a perspective view of a reed relay according to a third embodiment of the present disclosure;

FIG. 13 is a schematic view of a state of connection with a PCB according to the third embodiment of the present disclosure;

FIG. 14 is a perspective view of a reed relay according to a fourth embodiment of the present disclosure;

FIG. 15 is a top view of FIG. 14;

FIG. 16 is a sectional view taken along line C-C in FIG. 15;

FIG. 17 is a perspective view of a reed switch connected to a bobbin according to the fourth embodiment of the present disclosure;

FIG. 18 is a schematic view of a reed relay connected to a PCB according to the fourth embodiment of the present disclosure;

FIG. 19 is a schematic view of a reed relay connected to a PCB according to a fifth embodiment of the present disclosure;

FIG. 20 is a schematic view of a reed relay connected to a PCB according to a sixth embodiment of the present disclosure;

FIG. 21 is a perspective view of a reed relay according to the sixth embodiment of the present disclosure;

FIG. 22 is a schematic view of a reed relay connected to a PCB according to a seventh embodiment of the present disclosure;

FIG. 23 is a schematic view of a reed relay connected to a PCB according to an eighth embodiment of the present disclosure.

### DETAILED DESCRIPTION

Exemplary embodiments will now be described more comprehensively with reference to the accompanying drawings. However, the exemplary embodiments can be implemented in various forms and should not be construed as being limited to the implementations set forth herein. Although relative terms such as “up” and “down” are used in this specification to describe the relative relationship of one marked component to another marked component, these terms are used in this specification for convenience only, for example, according to directions of examples described in the drawings. It can be understood that if a marked device is turned upside down, a component described as being “up” will become a component as being “down”. Other relative terms such as “top” and “bottom” also have similar meanings. When a structure is “on” another structure, it may mean that the structure is integrally formed on the other structure, or that the structure is “directly” disposed on the other structure, or that the structure is “indirectly” disposed on the other structure through another structure.

Terms “one,” “an/a,” “the” and “said” are used to indicate existence of one or more elements/components/the like. Terms “including” and “having” are used in the sense of open-ended inclusion and indicate there may be additional elements/components/the like besides the listed elements/components/the like. Terms such as “first” and “second” are used merely as markers and do not limit the number of the objects referred to.

### Embodiment 1

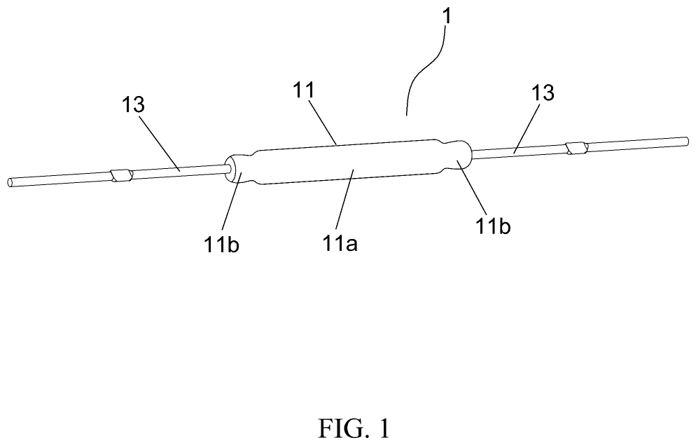

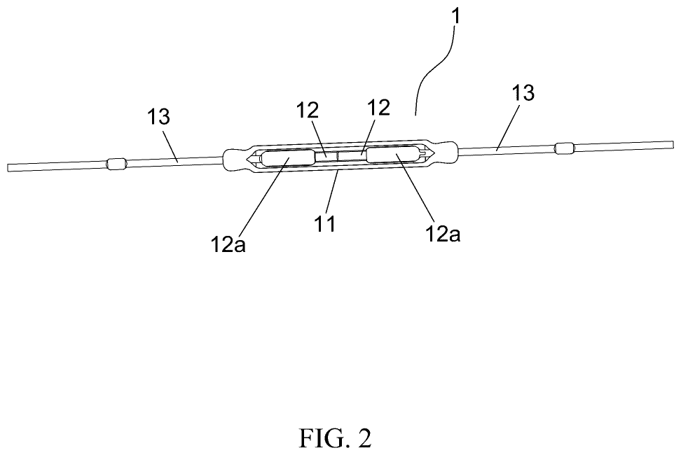

As shown in FIG. 1 and FIG. 2, a reed switch 1 includes a glass tube 11, the glass tube 11 includes a circular tube body 11a, a sintered section 11b is provided at each of two ends of the tube body 11a, and two contact reeds 12 capable of contacting or separating from each other are provided inside the tube body 11a. Two contact reed leading-out pins 13 respectively pass out of the two sintered sections 11b along a central axis of the tube body 11a, and the glass tube 11 is filled with inert gas or in a vacuum state. A connection section 12a for connecting the contact reed 12 with the contact reed leading-out pin 13 adopts a flat structure. Two connection sections 12a may be bent or inclined relative to the central axis of the tube body 11a, so that contacts of the two contact reeds 12 face each other and have a distance therebetween, and hence the contacts of the two contact reeds 12 can contact or be separated from each other, thereby achieving a switching function.

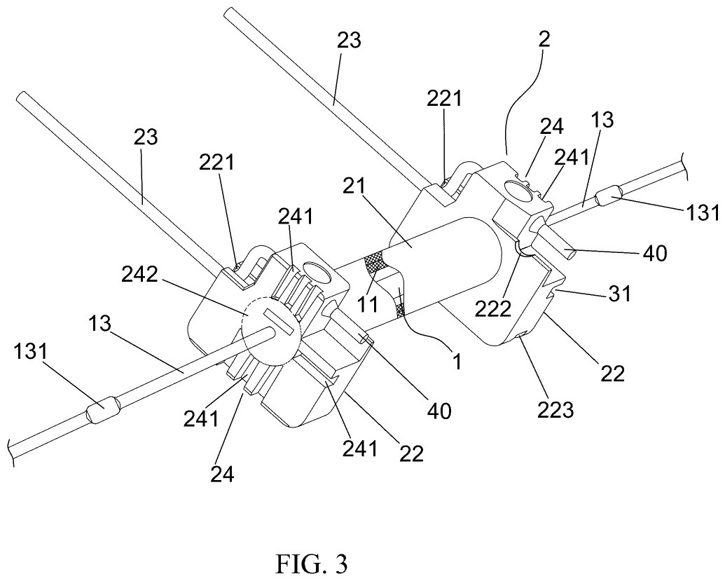

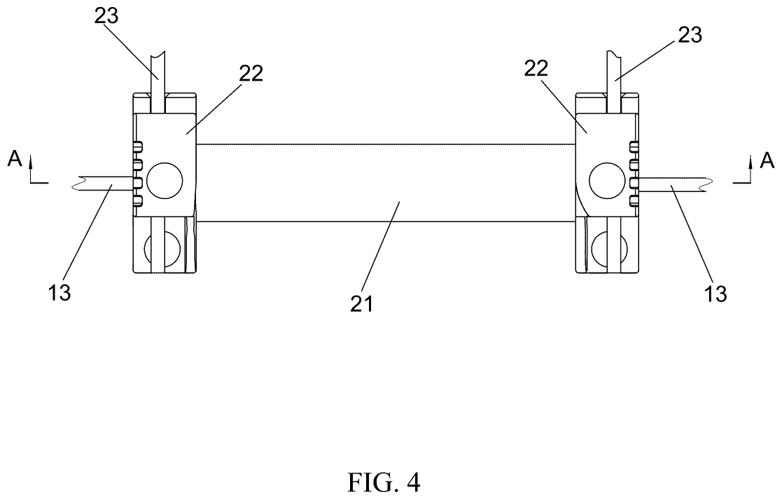

Referring to FIG. 3 to FIG. 5, for a reed relay according to a first embodiment of the present disclosure, a bobbin 2 is injection-molded and covers the entire glass tube 11. The bobbin 2 includes a circular tubular winding portion 21 and two head portions 22 connected to two ends of the winding portion 21, and a length of the circular tubular winding portion 21 is slightly longer than a length of the tube body 11a. One end of each of the two contact reed leading-out pins 13 passes out from a central position of an end surface of each of the two head portions 22. Each sintered section 11b is partially located in one head portion 22, or each sintered section 11b may also be entirely located in one head portion 22. A part of each contact reed leading-out pin 13 is covered and fixed by one head portion 22. Each head portion 22 is provided with a coil heat dissipation structure 24 close to the sintered section 11b. The head portion 22 has an outer end surface facing away from the winding portion 21 and a plurality of side surfaces connected to the outer end surface, and two outer end surfaces of the two head portions 22 are arranged oppositely.

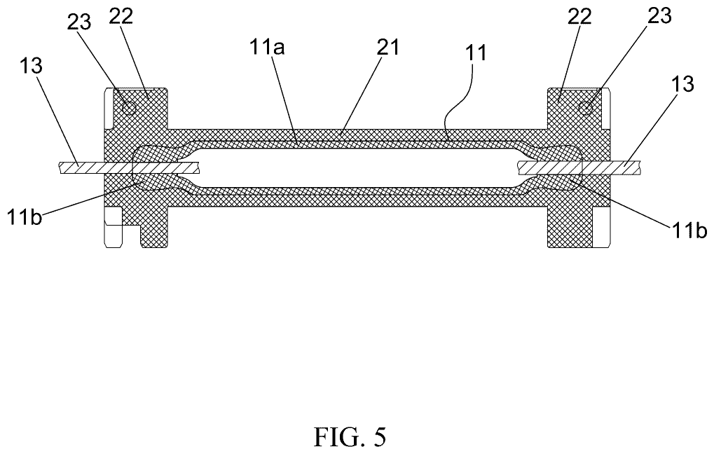

Referring to FIG. 3 and FIG. 5, a central axis of the circular tubular winding portion 21 coincides with the central axis of the tube body 11a; the coil heat dissipation structure 24 includes a plurality of heat dissipation grooves 241 on the outer end surface of the head portion 22, the plurality of heat dissipation grooves 241 are distributed around a cylindrical surface 242, and a central axis of the cylindrical surface 242 coincides with the central axis of the tube body 11a. One end of each heat dissipation groove 241 extends to a side surface of the head portion 22, and the other end thereof is located on the cylindrical surface 242.

One coil leading-out pin 23 passes through an upper part of each head portion 22, and an end 40 of each of two coil leading-out pins 23 is wound on and electrically connected to a corresponding one of two ends of an enameled wire of the coil.

Each of the two head portions 22 is provided with a positioning groove 221, and two positioning grooves 221 of the two head portions 22 are located at a same side of the winding portion 21. Another end of each coil leading-out pin 23 is partially located in the positioning groove 221 after being bent.

Each head portion 22 is provided with a wire passing groove 222 close to the one end 40 of the coil leading-out pin 23; the wire passing groove 222 may be configured to be U-shaped or V-shaped or arc-shaped; the wire passing groove 222 facilitates winding of the end of the enameled wire of the coil on the one end 40 of the coil leading-out pin 23; and at least one of the head portions 22 is provided with a winding clamping groove 223, to clamp and position the bobbin 2 and then perform winding to form the coil.

A shape of a cross-sectional profile of each of the head portions 22 along a direction perpendicular to the central axis of the tube body 11a includes a first rectangle and a second rectangle disposed in the middle of an upper surface of the first rectangle, and a size of the second rectangle is smaller than a size of the first rectangle in the direction perpendicular to the central axis of the tube body 11a.

The contact reed leading-out pin 13 is cylindrical, a middle part of each contact reed leading-out pin 13 passing out of the head portion 22 is machined with a flat portion 131, the flat portion 131 is parallel to a contact surface of a contact of the contact reed 12, or the flat portion 131 may be set to be perpendicular to the contact surface of the contact of the contact reed 12, both of which can better identify the direction of the contact surface of the contact of the contact reed 12. Meanwhile, when the bobbin 2 is formed by injection molding, the flat portion 131 can be used for positioning, to facilitate the assembly or machining of the housing in a subsequent process.

A central axis of the glass tube 11 coincides with a central axis of the bobbin 2, so that it is beneficial to realizing that a center of a contact of the contact reed 12 (where an air gap is the largest) coincides with a window center of the bobbin 2 (where magnetic flux of the coil is the densest), which cannot only make full use of the magnetic flux of the coil, but also improve consistency of electrical parameters and further improve the electrical performance.

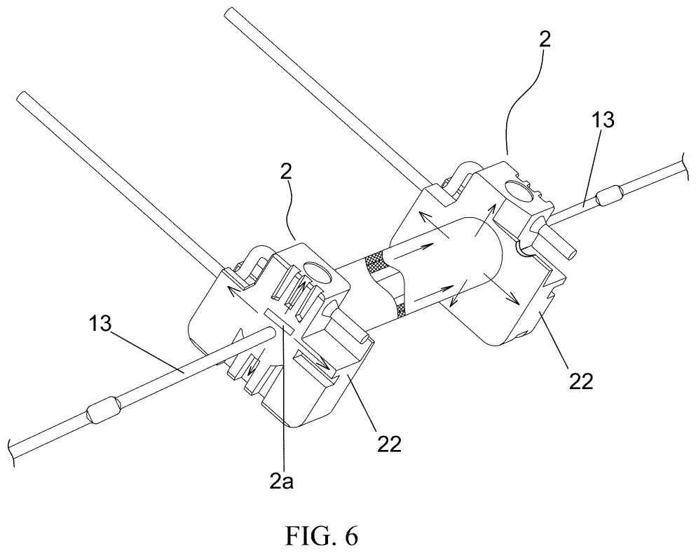

As shown in FIG. 5 and FIG. 6, an injection molding process portion 2a, such as an injection molding process port or an injection molding process protrusion, is formed on the bobbin 2. The injection molding process portion 2a is formed when the bobbin 2 is injection-molded outside the glass tube 11, and the injection molding process portion 2a corresponds to an injection port on an injection mold.

As shown in FIG. 6, the injection molding process portion 2a is disposed on one of the two head portions 22 and is located at a central position of the end surface of the head portion 22 away from the winding portion 21, and during injection molding, the plastic flows in axial and radial directions of the glass tube 11 (directions indicated by arrows in FIG. 6).

When the bobbin 2 is injection-molded, using a single injection port to inject plastic laterally can reduce an injection molding pressure, lowering a scouring force of plastic on the glass tube 11 and meanwhile ensure that the plastic in the sintered section 11b flows approximately in the radial direction, so as to ensure, to the greatest extent, that expansion of the plastic matches expansion of the glass (an expansion amount in a plastic flow direction is smaller than in a vertical flow direction and is closer to the expansion amount of the glass), and plastic flow directions of the sintered sections 11b at the two ends are consistent, thereby better protecting the glass tube 11 of the reed switch 1.

In addition, a reed relay in the related art typically includes a reed switch, a bobbin, a coil, and a housing, and the reed switch is a core component of the reed relay, so the difficulty in manufacturing the reed relay lies in how to ensure initial sealing performance of the reed switch to the greatest extent. The housing of the reed relay in the related art is mainly encapsulated by potting. The reed switch is first assembled with the coil and the bobbin into a magnetic circuit system, and then the magnetic circuit system is put into the housing for glue encapsulation. Such a structure adopting the glue encapsulation may easily separate out low-molecular-weight substances, thereby degrading the insulation performance of the reed relay, and may have defects that a cavity is easy to form in the interior and an outer surface of the glue is prone to bulging, thereby diminishing the overall quality of the reed relay. Moreover, the structure adopting the glue encapsulation makes it difficult to centrally dispose the magnetic circuit system in the housing, which also affects the overall quality of the reed relay.

The present disclosure further provides a reed relay that has good insulation performance and better ensures the initial sealing performance of the reed switch, improving the quality of the reed relay.

According to an aspect of the present disclosure, a reed relay includes a reed switch, a bobbin, a coil, and a housing. The reed switch includes a glass tube, and the glass tube includes a circular tube body. A sintered section is provided at each of two ends of the tube body. Two contact reeds capable of contacting or separating from each other are provided inside the tube body. Two contact reed leading-out pins respectively pass out of the two sintered sections along a central axis of the tube body. The glass tube is fixedly arranged in the middle of the bobbin. One end of each of the two contact reed leading-out pins passes out from a central position of each of two ends of the bobbin. The coil is wound on the bobbin. The housing is injection-molded and covers the bobbin and the coil. The two contact reed leading-out pins both partially pass out of the housing. The housing is provided with housing heat dissipation structures at two ends close to the bobbin.

According to an embodiment of the present disclosure, the bobbin is centrally disposed in the housing; and each housing heat dissipation structure includes a plurality of heat dissipation grooves disposed at an end of the housing, and the plurality of heat dissipation grooves are symmetrically disposed up and down with respect to a horizontal plane passing through the central axis of the tube body.

According to an embodiment of the present disclosure, the bobbin is injection-molded and entirely wraps the glass tube. The bobbin includes a circular tubular winding portion and two head portions connected to two ends of the winding portion, and each of the two contact reed leading-out pins passes out from a central position of an end surface of each of the two head portions along a central axis of the winding portion, respectively. The coil is wound on the winding portion, each sintered section is partially or entirely located in one head portion, and the glass tube is centrally disposed in the bobbin. One coil leading-out pin passes through each head portion, one end of each of two coil leading-out pins is electrically connected to a corresponding one of two ends of an enameled wire of the coil, and another end of each of two coil leading-out pins passes out of the housing.

In this way, the glass tube of the reed switch is covered by plastic, forming an overall rigid connection with the plastic, and avoiding disturbance of the glass tube caused by external vibration, so that a risk of sealing failure due to cracking of the glass tube or destruction of a bonding interface of the sintered section caused by the disturbance is avoided, to ensure the initial sealing performance of the glass tube of the reed switch, and effectively improve the anti-vibration performance.

Moreover, the glass tube is centrally disposed in the bobbin, which is conductive to realizing that a center of a contact of the contact reed (where an air gap is the largest) coincides with a window center of the bobbin (where magnetic flux of the coil is the densest), which cannot only make full use of the magnetic flux of the coil, but also improve consistency of electrical parameters and further improve the electrical performance

According to an embodiment of the present disclosure, each of the two head portions is provided with a positioning groove, two positioning grooves are located at a same side of the winding portion, and each coil leading-out pin is partially located in the positioning groove after being bent.

The coil leading-out pins are restrained by the positioning grooves in a length direction and in a height direction, so that the coil leading-out pins are prevented from being skewed and unable to fit into a mold cavity before injection molding of the housing, or from being deformed by plastic scouring during the injection molding of the housing.

According to an embodiment of the present disclosure, the housing is provided with two pairs of limiting grooves, the two pairs of limiting grooves are respectively close to the two head portions, and each pair of limiting grooves is disposed at two sides of the housing.

The bobbin may be restrained by the limiting grooves in a width direction of the housing, to ensure that the bobbin is centered in the housing, and finally achieve the uniformity and symmetry of expansion of the housing in all directions.

According to an embodiment of the present disclosure, the two coil leading-out pins and the two contact reed leading-out pins passing out of the housing are respectively located at two sides of the housing; each coil leading-out pin passing out of the housing is close to one side of the housing heat dissipation structure; and each contact reed leading-out pin passing out of the housing is close to another side of the housing heat dissipation structure.

In this way, a creepage distance between the contact reed leading-out pin and the coil leading-out pin can be increased through the housing heat dissipation structure, thereby improving the electrical performance.

According to an embodiment of the present disclosure, the bobbin has the same material characteristics as the housing.

According to an embodiment of the present disclosure, the contact reed leading-out pin has a cylindrical body. Each contact reed leading-out pin passing out from the central position of the end surface of the head portion of the bobbin is bent by 90° in a horizontal direction to form a first bent section, the first bent section is provided with a flat portion, the flat portion is perpendicular to or parallel to a contact surface of a contact of the contact reed. The flat portion is first used for positioning and injection molding to form the bobbin, and then the flat portion is used for positioning; or the bobbin is used for positioning and injection molding to form the housing, and the flat portion is wrapped in the housing.

In this way, the contact reed leading-out pin and the housing can be combined more firmly, and a direction of the contact surface of the contact of the contact reed can be better identified, which facilitates determination of an installation direction of the reed relay, and guarantees the working performance of the reed relay to the greatest extent.

According to an embodiment of the present disclosure, the flat portion includes two parallel planes, the two parallel planes are parallel or perpendicular to a contact plane of the contact of the contact reed, a distance between the two parallel planes is smaller than a diameter of the body of the contact reed leading-out pin, and an oblique angle is formed at a joint of the two parallel planes and the body of the contact reed leading-out pin.

In this way, a pit formed by the parallel planes and the oblique angle is filled with plastic, and the plastic acts as a positioning pin, effectively preventing the contact reed leading-out pin from rotating in a circumferential direction, and avoiding a situation that the sealing performance of the reed switch is diminished due to rotation of the contact reed leading-out pin under the action of external force in a bending process. Moreover, the oblique angle is beneficial to separation of mold inserts and the parts, avoiding deformation caused by pulling the parts during demolding.

According to an embodiment of the present disclosure, a part of the first bent section passes out of the housing is bent by 90° again in a longitudinal direction to form a second bent section. When the reed relay is mounted on a PCB (printed circuit board), the second bent section is inserted into or fitted with the PCB, and the contact surface of the contact of the contact reed is perpendicular to the PCB. In this way, the anti-vibration and anti-impact performance of the reed relay can be improved, and malfunction can be prevented.

According to an embodiment of the present disclosure, each of the head portions is provided with a coil heat dissipation structure close to the sintered section.

By providing each head portion with the coil heat dissipation structure close to the sintered section, the influence that plastic, glass and metal cannot synchronously expand is reduced, and the influence on the initial sealing performance of the glass tube due to extrusion caused by uneven thermal stress is avoided.

According to an embodiment of the present disclosure, a central axis of the circular tubular winding portion coincides with the central axis of the tube body, the coil heat dissipation structure includes a plurality of heat dissipation grooves disposed on the head portion, the plurality of heat dissipation grooves are distributed around a cylindrical surface, and a central axis of the cylindrical surface coincides with the central axis of the tube body.

According to an embodiment of the present disclosure, a bottom of the housing is provided with a plurality of limiting protrusions. When the reed relay is mounted on the PCB, the plurality of limiting protrusions restricts a distance between the bottom of the housing and the PCB, to ensure sufficient space for heat dissipation when the reed relay works.

The present disclosure has the following beneficial effects.
1. The housing is injection-molded and covers the bobbin and the coil; the two coil leading-out pins and the two contact reed leading-out pins pass out of the housing; and the housing is provided with the housing heat dissipation structures at two ends close to the bobbin. Through the housing heat dissipation structures, the heat conduction effect of the plastic can be improved, an heat exchange area between the plastic and air during use of the product can be increased, and a contact area between the plastic and the mold in the injection molding process can also be increased, thereby improving the heat conduction/heat dissipation effect, achieving synchronous heat conduction of ‘metal-glass’ and ‘plastic-glass’, avoiding a situation that an excessive temperature gradient is generated around the sintered section of the glass tube before thermal equilibrium and widens the difference in expansion between different materials (which may cause adjacent materials to be subjected to a thermal stress effect due to mismatch in expansion), preventing the glass tube from being damaged by extrusion or tensile stress, ensuring the initial sealing performance of the reed switch, and upgrading the quality of the reed relay.
2. The capability of insulation between input and output is improved. The housing and the bobbin are integrally injection-molded, so that defects of easy separation of low-molecular-weight substances due to potting, degradation of the insulation performance, easy formation of the cavity, and easy bulging of the glue surface can be avoided, thereby improving the insulation performance, and upgrading the quality of the reed relay. Further, the creepage distance between the contact reed leading-out pin and the coil leading-out pin can be increased through the heat dissipation structures, thereby improving the electrical performance.
3. The assembly precision of the bobbin in the housing is improved, to better ensure that the bobbin is centered in the housing, achieve the uniformity and symmetry of the plastic wall thickness of the housing in all directions, and guarantee the uniformity and symmetry of expansion to the greatest extent.

### Embodiment 2

As shown in FIG. 1 and FIG. 2, a reed switch 1 includes a glass tube 11, the glass tube 11 includes a circular tube body 11a, a sintered section 11b is provided at each of two ends of the tube body 11a, and two contact reeds 12 capable of contacting or separating from each other are provided inside the tube body 11a. Two contact reed leading-out pins 13 respectively pass out of the two sintered sections 11b along a central axis of the tube body 11a, and the glass tube 11 is filled with inert gas or in a vacuum state. A connection section 12a for connecting the contact reed 12 with the contact reed leading-out pin 13 adopts a flat structure. Two connection sections 12a may be bent or inclined relative to the central axis of the tube body 11a, so that contacts of the two contact reeds 12 face each other and have a distance therebetween, and hence the contacts of the two contact reeds 12 can contact or be separated from each other, thereby achieving a switching function.

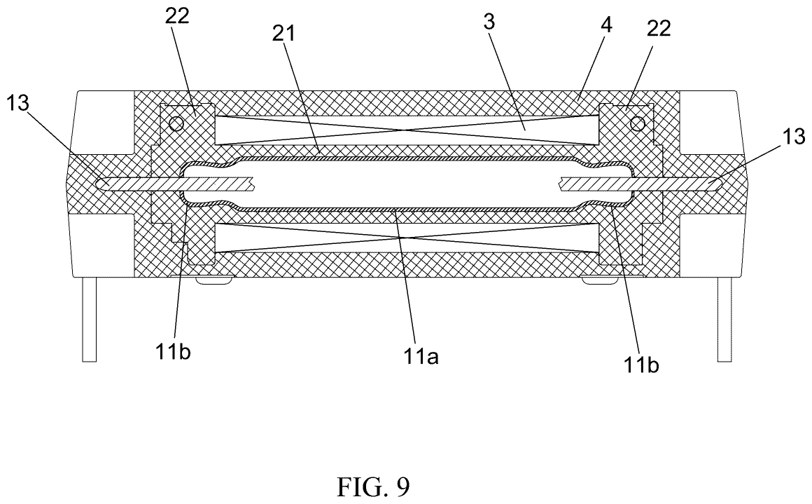

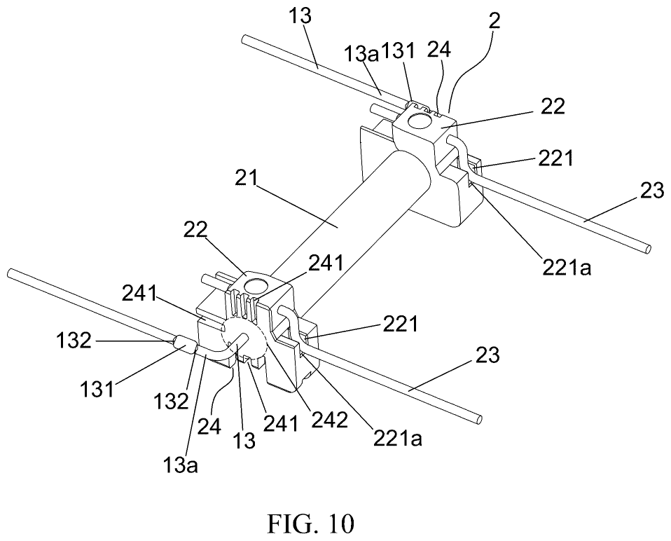

Referring to FIG. 9 and FIG. 10, a reed relay according to a second embodiment of the present disclosure includes the reed switch 1, a bobbin 2, a coil 3 and a housing 4. The glass tube 11 is fixedly arranged in the middle of the bobbin 2, and two contact reed leading-out pins 13 respectively pass out of central positions of two ends of the bobbin 2. The coil 3 is wound on the bobbin 2, two coil leading-out pins 23 are fixedly arranged on the bobbin 2 and spaced apart from each other, and the two coil leading-out pins 23 are respectively wound on and electrically connected to two ends of an enameled wire of the coil 3.

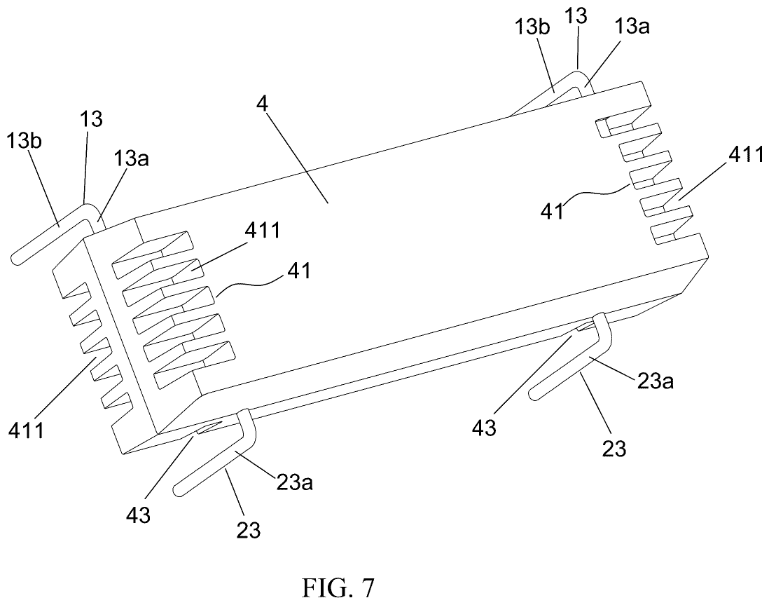

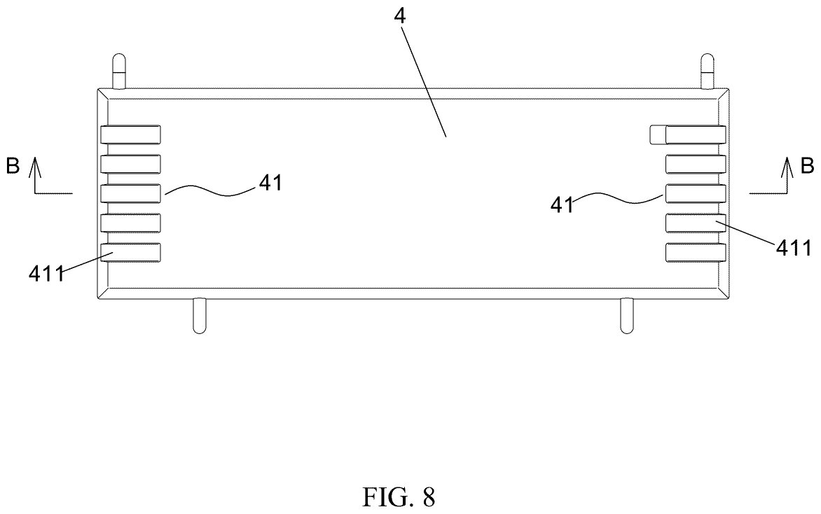

Referring to FIG. 7 to FIG. 9, the housing 4 is injection-molded and covers the bobbin 2 and the coil 3, the bobbin 2 is centrally disposed in the housing 4, and the two coil leading-out pins 23 and the two contact reed leading-out pins 13 all partially pass out of the housing 4. The housing 4 is provided with housing heat dissipation structures 41 at two ends close to the bobbin 2. Each housing heat dissipation structure 41 includes a plurality of heat dissipation grooves 411 disposed at an end of the housing 4, and the plurality of heat dissipation grooves 411 are symmetrically disposed up and down with respect to a horizontal plane passing through the central axis of the tube body 11a.

Referring to FIG. 9 to FIG. 10, the bobbin 2 is injection-molded and covers the entire glass tube 11. The bobbin 2 includes a circular tubular winding portion 21 and two head portions 22 connected to two ends of the winding portion 21. Each of the two contact reed leading-out pins 13 passes out from a central position of each of the two head portions 22 along a central axis of the winding portion 21. The coil 3 is wound on the winding portion 21, each sintered section 11b is partially located in the head portion 22 or entirely located in the head portion 22. The glass tube 11 is centrally disposed in the bobbin 2, that is, the central axis of the tube body 11a coincides with a central axis of the bobbin 2. One coil leading-out pin 23 passes through each head portion 22, and one end of each of two coil leading-out pins 23 is wound on and electrically connected to a corresponding one of two ends of the enameled wire of the coil 3.

Referring to FIG. 10, each of the two head portions 22 is provided with one positioning groove 221, and two positioning grooves 221 are located at a same side of the winding portion 21. Each coil leading-out pin 23 is partially located in the positioning groove 221 after being bent. A chamfer 221a is provided at an opening of the positioning groove 221, which facilitates inflow of the plastic during the injection molding of the housing 4.

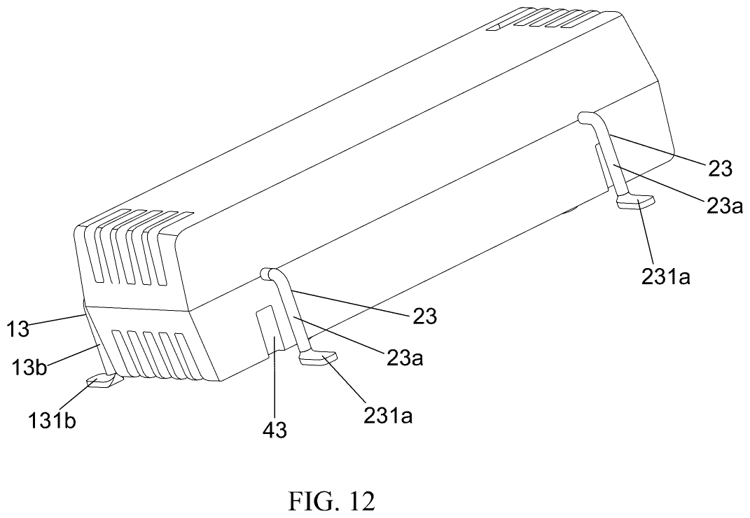

Referring to FIG. 12, the housing 4 is provided with two pairs of limiting grooves 43, the two pairs of limiting grooves 43 are respectively close to the two head portions, and each pair of limiting grooves 43 is disposed at two sides of the housing 4. The bobbin 2 can be restrained in a width direction of the housing 4 by the limiting grooves 43 at both sides of the housing 4, to ensure that the bobbin 2 is centered in the housing 4, thereby achieving the uniformity and symmetry of expansion of the housing 4 in all directions.

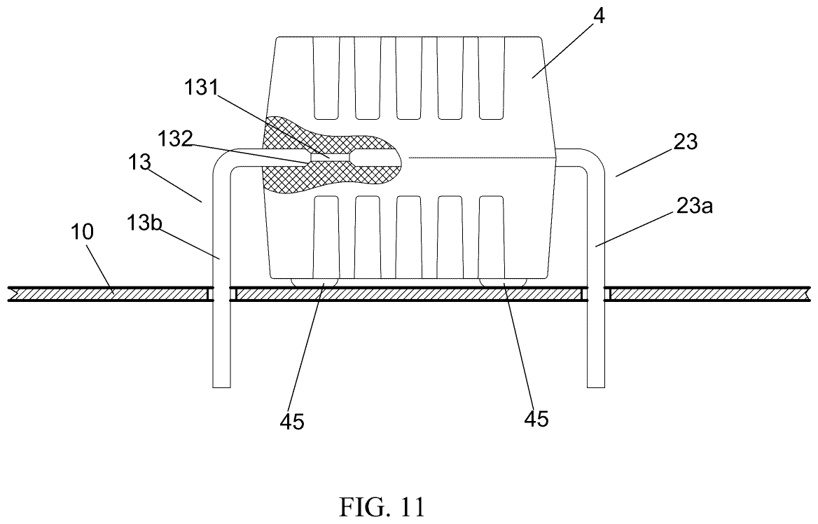

Referring to FIG. 11, the two coil leading-out pins 23 and the two contact reed leading-out pins 13 passing out of the housing 4 are respectively located at two sides of the housing 4; each coil leading-out pin 23 passing out of the housing 4 is close to and located at one side of the housing heat dissipation structure 41; and each contact reed leading-out pin 13 passing out of the housing 4 is close to and located at another side of the housing heat dissipation structure 41. In this way, a creepage distance between the coil leading-out pin 23 and the contact reed leading-out pin 13 can be increased.

Referring to FIG. 10, each head portion 22 is provided with a coil heat dissipation structure 24 close to the sintered section 11b. A central axis of the circular tubular winding portion 21 coincides with the central axis of the tube body 11a. The coil heat dissipation structure 24 includes a plurality of heat dissipation grooves 241 disposed on the head portion 22. The plurality of heat dissipation grooves 241 are distributed around a cylindrical surface 242, and a central axis of the cylindrical surface 242 coincides with the central axis of the tube body 11a.

The contact reed leading-out pin 13 has a cylindrical body. Before the housing 4 is injection-molded, as shown in FIG. 10, each contact reed leading-out pin 13 passing out from the central position of the head portion 22 of the bobbin 2 is bent by 90° in a horizontal direction to form a first bent section 13a, the first bent section 13a is provided with a flat portion 131, the flat portion 131 is perpendicular to or parallel to a contact surface of a contact of the contact reed 12. The flat portion 131 is first used for positioning and injection molding to form the bobbin 2, and then the flat portion 131 is used for positioning; or the bobbin 2 is used for positioning and injection molding to form the housing 4, and the flat portion 131 is wrapped in the housing 4.

Referring to FIG. 10 and FIG. 11, the flat portion 131 includes two parallel planes that are perpendicular to a contact plane of the contact of the contact reed 12 or may be parallel to the contact plane of the contact of the contact reed 12. A distance between the two parallel planes is smaller than a diameter of the body of the contact reed leading-out pin 13, and an oblique angle 132 is formed at a joint of the two parallel planes and the body of the contact reed leading-out pin 13. In this way, a pit formed by the parallel planes and the oblique angle 132 is filled with plastic, and the plastic acts as a positioning pin, which can effectively prevent the contact reed leading-out pin 13 from rotating in a circumferential direction, and avoid a situation that the sealing performance of the reed switch 1 is diminished due to rotation of the contact reed leading-out pin 13 under the action of external force in a bending process. Moreover, the oblique angle 132 is beneficial to separation of mold inserts and the parts, avoiding deformation caused by pulling the parts during demolding.

The material characteristics for injection molding of the bobbin 2 are the same as the material characteristics for injection molding of the housing 4.

Referring to FIG. 11, a part of the first bent section 13a passes out of the housing 4 is bent by 90° again in a longitudinal direction to form a second bent section 13 b. When the reed relay according to this embodiment is mounted on a PCB 10, the second bent section 13b is plugged into the PCB 10, and the contact surface of the contact of the contact reed 12 is perpendicular to the PCB 10. Such a structure facilitates the plug-in installation between the PCB 10 and this embodiment, and can also effectively improve the anti-vibration and anti-impact performance of this embodiment, preventing malfunction. In order to facilitate the plug-in installation with the PCB 10, each of the two coil leading-out pins 23 passing out of the housing 4 is bent by 90° along the longitudinal direction to form a plug-in section 23a, and two plug-in sections 23a are plugged into the PCB 10.

In this embodiment, the two parallel planes of the flat portion 131 are parallel to the PCB 10. As a variation, the two parallel planes of the flat portion 131 may be perpendicular to the PCB 10.

A bottom of the housing 4 is provided with four limiting protrusions 45, and when the reed relay is mounted on the PCB 10, the four limiting protrusions 45 restricts a distance between the bottom of the housing 4 and the PCB 10.

### Embodiment 3

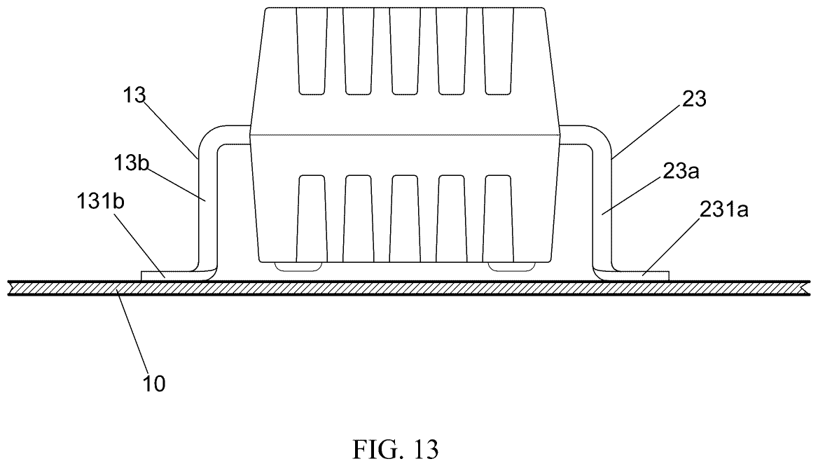

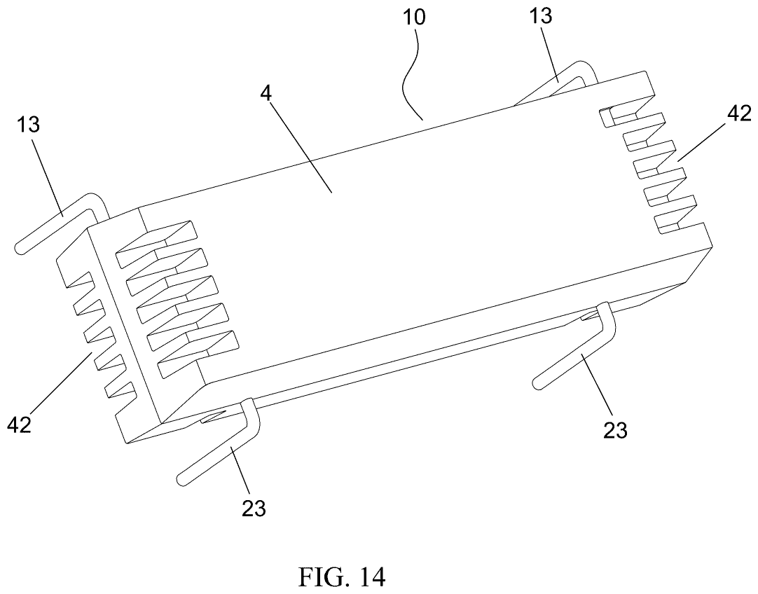

As shown in FIG. 12 to FIG. 14, the structure of the reed relay according to a third embodiment of the present disclosure differs from that of the first embodiment in that: a lower end of the second bent section 13b is bent by 90° again in the horizontal direction to form a flat fitting portion 131b. When the reed relay according to this embodiment is mounted on the PCB 10, the flat fitting portion 131b at the lower end of the second bent section 13b is fitted with the PCB 10, to facilitate the fitting installation. In such a case, a lower end of the plug-in section 23a of each of the two coil leading-out pins 23 is also bent by 90° again in the horizontal direction to form a second flat fitting portion 231a, and the second flat fitting portion 231a is fitted with the PCB 10. This embodiment facilitates the fitting installation with the PCB 10.

In addition, the reed relay of the related art usually includes a reed switch, a bobbin, a coil, and a housing. The reed switch includes a glass tube, and two contact reeds are arranged in the glass tube, and two contact reed leading-out pins pass out of two ends of the glass tube. The coil is wound on the bobbin, and the glass tube is fixedly connected to the middle of the bobbin. The housing covers the bobbin and the coil and is sealed by potting, and two contact reed leading-out pins and two coil leading-out pins pass out of the housing. Most reed relays need to be mounted on a PCB (printed circuit board) to function properly, which is achieved by mounting on the PCB through two contact reed leading-out pins and two coil leading-out pins. However, since the contact reed leading-out pins in the reed switch are cylindrical, and the tube body in the reed switch is circular tubular, when the reed switch is fixedly connected to the middle of the bobbin, the position of the reed switch in the circumferential direction is random and is difficult to locate and set up, that is, a contact position of the contact reed is random. Once the reed relay is mounted on the PCB, a plane of a contact of the contact reed is parallel to the PCB, and at this time, the contact of the contact reed has the weakest anti-impact and anti-vibration ability, and malfunction may occur, affecting the working reliability of the reed relay, and diminishing the anti-impact ability of the reed relay.

The present disclosure further provides a reed relay, which can improve the anti-impact ability of the contact in the reed relay and prevent malfunction of the reed relay.

According to an aspect of the present disclosure, a reed relay includes a reed switch, a bobbin, a coil, and a housing. The reed switch includes a glass tube, and the glass tube includes a circular tube body. A sintered section is provided at each of two ends of the tube body. Two contact reeds capable of contacting or separating from each other are provided inside the tube body. Two contact reed leading-out pins pass out of the two sintered sections. The glass tube is fixedly connected to the middle of the bobbin. One end of each of the two contact reed leading-out pins passes out from a corresponding one of two ends of the bobbin. The coil is wound on the bobbin, and the bobbin and the coil are covered by the housing. The contact reed leading-out pin has a conductive cylindrical body, at least one contact reed leading-out pin passing out of the two ends of the bobbin is provided with a flat portion, and the flat portion is parallel to or perpendicular to a contact plane of a contact of the contact reed. The two contact reed leading-out pins pass out of the housing and then are connected with a PCB. Positioning is performed by the flat portion of the contact reed leading-out pin, so that the contact plane of the contact of the contact reed is perpendicular to the PCB.

According to an embodiment of the present disclosure, the housing is formed in such a way that it is positioned by the flat portion and then is injection-molded to cover the bobbin and the coil, so as to improve bonding strength and insulation performance.

According to an embodiment of the present disclosure, the flat portion is located inside the housing and combined with the housing. Since the flat portion is covered by the plastic housing, the contact reed leading-out pin passing out of the housing can be prevented from rotating under a tangential force in a circumferential direction during subsequent processing, thereby improving an anti-rotation effect on the contact reed leading-out pin, and further reducing a risk that an external mechanical acting force may damage the sealing performance of the sintered section of the glass body.

According to an embodiment of the present disclosure, the flat portion is located outside the housing, and after the contact reed leading-out pin is connected to the PCB, the flat portion abuts against an upper end of the PCB to limit a distance between the bottom of the housing and the PCB, or the flat portion is fitted with an upper end of the PCB to form an electrical connection. In this way, when the flat portion plays a limiting role, the heat dissipation effect on the reed relay can be enhanced, and when the flat portion is fitted with the upper end of the PCB to form the electrical connection, the reed relay can be fitted and mounted conveniently, and a limiting effect can be realized at the same time.

According to an embodiment of the present disclosure, the two contact reed leading-out pins passing out of the two ends of the bobbin are each provided with two flat portions; one flat portion on each contact reed leading-out pin is located inside the housing and combined with the housing, while the other flat portion is located outside the housing, and after the contact reed leading-out pin is connected to the PCB, the flat portion located outside the housing abuts against the upper end of the PCB to limit the distance between the bottom of the housing and the PCB, or the flat portion is fitted with the upper end of the PCB to form an electrical connection. In this way, through the two flat portions, the anti-rotation effect on the contact reed leading-out pin can be improved, the reed relay can be conveniently fitted and mounted, and the limiting effect can be achieved.

According to an embodiment of the present disclosure, the bottom of the housing is provided with a plurality of limiting protrusions, and when the reed relay is mounted on the PCB, the plurality of limiting protrusions restricts the distance between the bottom of the housing and an upper end surface of the PCB, which facilitates heat dissipation of the reed relay during operation.

According to an embodiment of the present disclosure, the flat portion includes two parallel planes, the two parallel planes are parallel or perpendicular to a contact plane of the contact of the contact reed, a distance between the two parallel planes is smaller than a diameter of the body of the contact reed leading-out pin, and an oblique angle is formed at a joint of the two parallel planes and the body of the contact reed leading-out pin. In this way, a pit formed by the parallel planes and the oblique angle is filled with plastic, and the plastic acts as a positioning pin, effectively preventing the contact reed leading-out pin from rotating in a circumferential direction, and avoiding that the sealing performance of the reed switch is diminished due to rotation of the contact reed leading-out pin under the action of external force during processing. The oblique angle is beneficial to separation of mold inserts and the parts, avoiding deformation caused by pulling the parts during demolding.

According to an embodiment of the present disclosure, the bobbin is injection-molded and entirely wraps the glass tube. The bobbin includes a circular tubular winding portion and two head portions connected to two ends of the winding portion, and each of the two contact reed leading-out pins passes out from a central position of an end surface of each of the two head portions along a central axis of the winding portion, respectively. The coil is wound on the winding portion, and each sintered section is partially or entirely located in one head portion. One coil leading-out pin passes through each head portion, and one end of each of two coil leading-out pins is electrically connected to a corresponding one of two ends of an enameled wire of the coil. Two coil leading-out pins pass out of the housing and are connected to the PCB. Such a structure can improve the anti-disturbance and anti-cracking capability of the glass tube of the reed switch, ensure the initial sealing performance of the glass tube of the reed switch, and facilitate automated production.

According to an embodiment of the present disclosure, the flat portion is used for positioning and injection molding to form the bobbin, each of the two head portions is provided with a positioning groove, two positioning grooves are disposed at a same side of the winding portion, and each coil leading-out pin is partially located in the positioning groove after being bent, to facilitate the housing to cover the bobbin and the coil by injection molding in a later period.

According to an embodiment of the present disclosure, each of the head portions is provided with a coil heat dissipation structure close to the sintered section. A central axis of the circular tubular winding portion coincides with the central axis of the tube body. The coil heat dissipation structure includes a plurality of heat dissipation grooves disposed on the head portion, the plurality of heat dissipation grooves are distributed around a cylindrical surface, and a central axis of the cylindrical surface coincides with the central axis of the tube body. Through the coil heat dissipation structure, the influence that plastic, glass and metal cannot synchronously expand is reduced, and the influence on the initial sealing performance of the glass tube due to extrusion caused by uneven thermal stress is avoided. Meanwhile, the coil heat dissipation structure can increase the creepage distance of the connection structure, and have an effect of reducing the centrifugal effect of winding the coil on the bobbin after weight reduction.

According to the present disclosure, at least one contact reed leading-out pin passing out of the two ends of the bobbin is provided with the flat portion, and the flat portion is parallel to or perpendicular to the contact plane of the contact of the contact reed, so that the direction of the contact plane of the contact of the contact reed is conveniently identified. When the two contact reed leading-out pins pass out of the housing and then are connected with the PCB, it can be ensured that the contact plane of the contact of the contact reed faces a set direction, and is perpendicular to the PCB by positioning of the flat portion of the contact reed leading-out pin. The contact plane of the contact of the contact reed is perpendicular to the PCB, which may have the strongest anti-vibration ability, improve the anti-vibration and anti-impact ability of the contact in the reed relay, and effectively prevent malfunction of the reed relay.

Further, the flat portion also has an anti-rotation function, which can reduce a risk that the sealing performance of the glass tube is damaged due to rotational displacement between the contact reed and the glass sintered section caused by external torque.

### Embodiment 4

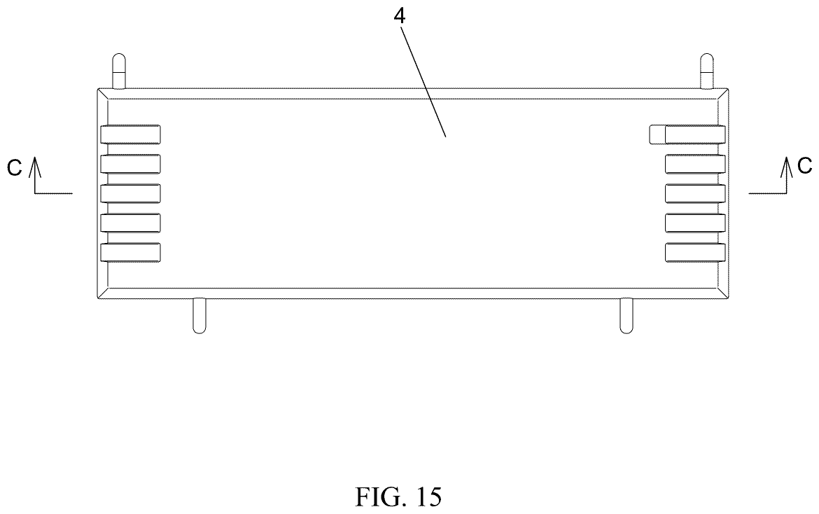

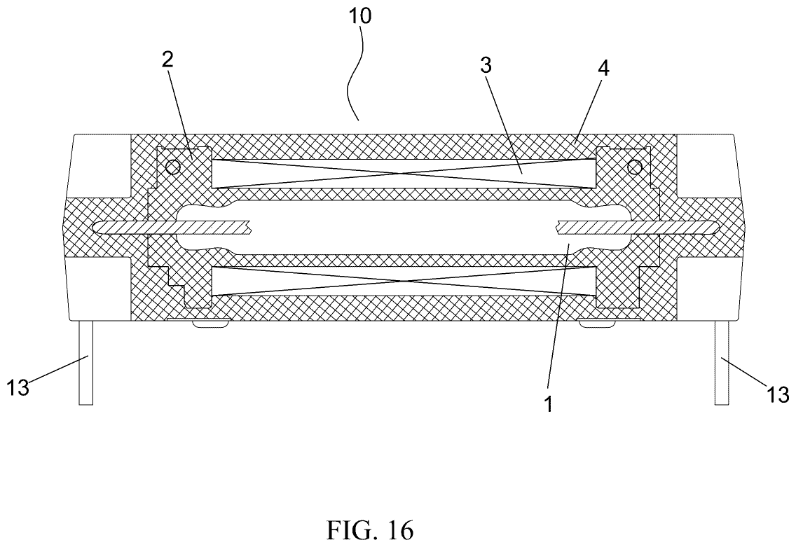

As shown in FIG. 1, FIG. 2 and FIGS. 14-18, a reed relay 10 according to a fourth embodiment of the present disclosure includes a reed switch 1, a bobbin 2, a coil 3, and a housing 4. The reed switch 1 includes a glass tube 11, the glass tube 11 includes a circular tube body 11a, a sintered section 11b is provided at each of two ends of the tube body 11a, and two contact reeds 12 capable of contacting or separating from each other are provided inside the tube body 11a. Two contact reed leading-out pins 13 pass out of the two sintered sections 11b, respectively. The glass tube 11 is filled with inert gas or in a vacuum state. The glass tube 11 is fixedly connected to the middle of the bobbin 2, and one end of each of the two contact reed leading-out pins 13 passes out from a corresponding one of two ends of the bobbin 2. Specifically, the reed switch 1 is connected with the bobbin 2 in such a way that the bobbin 2 is injection-molded and covers the entire glass tube 11. The bobbin 2 includes a circular tubular winding portion 21 and two head portions 22 connected to two ends of the winding portion 21. Each of the two contact reed leading-out pins 13 passes out from a central position of each of the two head portions 22 along a central axis of the winding portion 21. The glass tube 11 of the reed switch 1 is centrally disposed in the bobbin 2, and the coil 3 is wound on the winding portion 21. Each sintered section 11b is partially located in one head portion 22, or each sintered section 11b may also be entirely located in one head portion 22. One coil leading-out pin 23 passes through each head portion 22, and one end of each of two coil leading-out pins 23 is electrically connected to a corresponding one of two ends of an enameled wire of the coil 3. Two coil leading-out pins 23 pass out of the housing 4 and are connected to a PCB 20.

Each of the two head portions 22 is provided with a positioning groove 221, and two positioning grooves 221 are located at a same side of the winding portion 22. Each coil leading-out pin 23 is partially located in the positioning groove 221 after being bent.

Each head portion 22 is provided with a coil heat dissipation structure 24 close to the sintered section 11b. A central axis of the circular tubular winding portion 21 coincides with the central axis of the tube body 11a. The coil heat dissipation structure 24 includes a plurality of heat dissipation grooves 241 disposed on the head portion 22. The plurality of heat dissipation grooves 241 are distributed around a cylindrical surface 242, and a central axis of the cylindrical surface 242 coincides with the central axis of the tube body 11a.

The bobbin 2 and the coil 3 are covered by the housing 4. The contact reed leading-out pin 13 has a conductive cylindrical body. Each of two contact reed leading-out pins 13 passing out of the two ends of the bobbin 2 is provided with a flat portion 131, and the flat portions 131 may be disposed parallel to or perpendicular to a contact plane of a contact of the contact reed 12, to identify an orientation of the contact plane of the contact of the contact reed 12. The bobbin 12 is injection-molded by using the flat portions 131 for positioning.

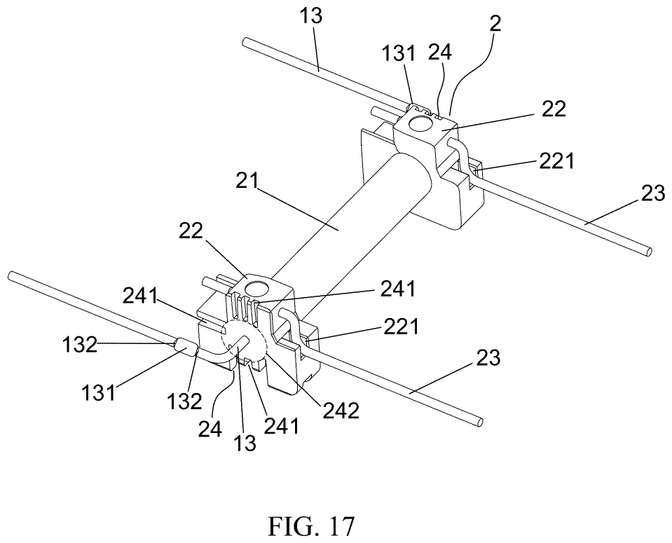

As shown in FIG. 17, the flat portions 131 are perpendicular to the contact plane of the contact of the contact reed 12 after the two contact reed leading-out pins 13 passing through the two ends of the bobbin 2 are bent by 90° in the horizontal direction.

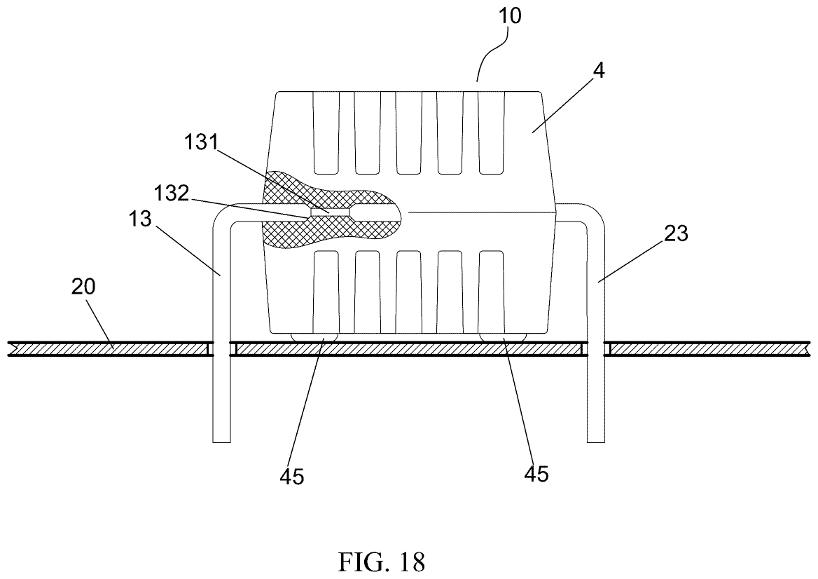

As shown in FIG. 18, after the two contact reed leading-out pins 13 pass out of the housing 4, the two contact reed leading-out pins 13 are both bent by 90° again in the longitudinal direction and then connected to the PCB 20. The contact plane of the contact of the contact reed 12 is perpendicular to the PCB 20 by using the flat portions 131 of the contact reed leading-out pins 13 for positioning.

In Embodiment 4, the housing 4 is formed in such a way that it is positioned by the flat portion 131 and then is injection-molded to cover the bobbin 2 and the coil 3. The flat portion 131 is located inside and combined with the housing 4. The flat portion 131 includes two parallel planes, the two parallel planes are perpendicular to or may be parallel to the contact plane of the contact of the contact reed 12. A distance between the two parallel planes is smaller than a diameter of the body of the contact reed leading-out pin 13, and an oblique angle 132 is formed at a joint of the two parallel planes and the body of the contact reed leading-out pin 13. In this way, a pit formed by the parallel planes and the oblique angle 132 is filled with plastic, and the plastic acts as a positioning pin, which can effectively prevent the contact reed leading-out pin 13 from rotating in a circumferential direction, and avoid that the sealing performance of the reed switch is diminished due to rotation of the contact reed leading-out pin 13 under the action of external force during processing. Moreover, the oblique angle 132 is beneficial to separation of mold inserts and the parts, avoiding deformation caused by pulling the parts during demolding. In Embodiment 4, two parallel planes of the flat portion 131 are parallel to the PCB 20. As a variation, the two parallel planes of the flat portion 131 may be perpendicular to the PCB 20.

A bottom of the housing 4 is provided with four limiting protrusions 45, and when the reed relay is mounted on the PCB 20, the four limiting protrusions 45 restricts a distance between the bottom of the housing 4 and an upper end surface of the PCB 20, which facilitates heat dissipation of the reed relay 10 during operation, and facilitates plug-in connection between the reed relay 10 and the PCB 20.

In this embodiment, the material characteristics for injection molding of the bobbin 2 are the same as the material characteristics for injection molding of the housing 4. Two ends of the housing 4 are also provided with housing heat dissipation structures 41.

When the reed relay 10 according to this embodiment is working, since the contact plane of the contact of the contact reed 12 is perpendicular to the PCB 20, the anti-impact ability of the contact of the reed relay 10 can be improved, thereby preventing malfunction.

### Embodiment 5

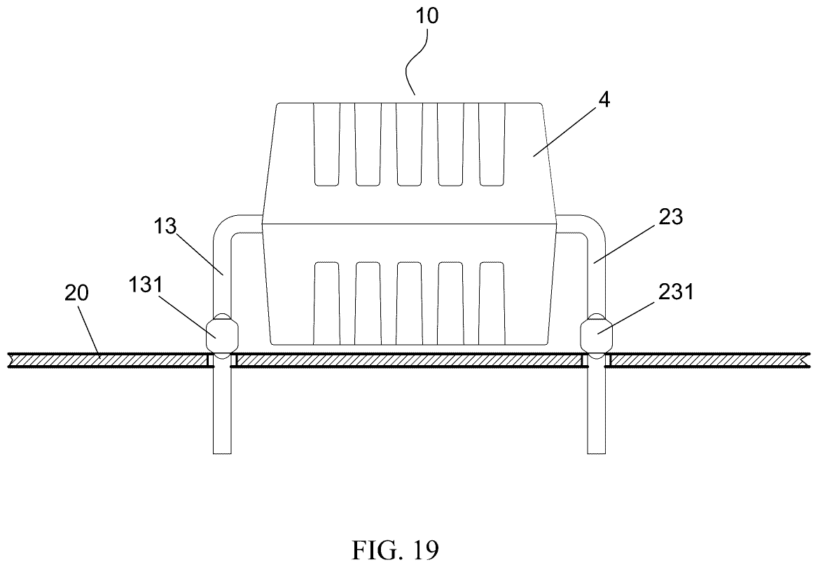

As shown in FIG. 19, a reed relay according to a fifth embodiment of the present disclosure differs from that of the fourth embodiment in that: the flat portion 131 is located outside the housing 4, and after the contact reed leading-out pin 13 of the reed relay 10 is connected to the PCB 20, the flat portion 131 abuts against an upper end of the PCB 20 to limit the distance between the bottom of the housing 4 and the PCB 20. Meanwhile, the two coil leading-out pins 23 are also correspondingly provided with flat portions 231 and abut against the upper end of the PCB 20. In Embodiment 5, there is no need to provide any limiting protrusion at the bottom of the housing 4.

### Embodiment 6

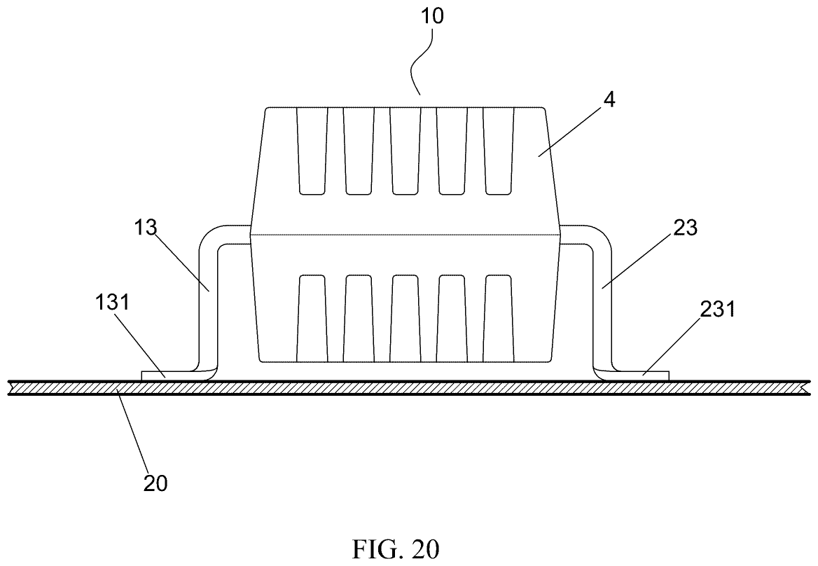

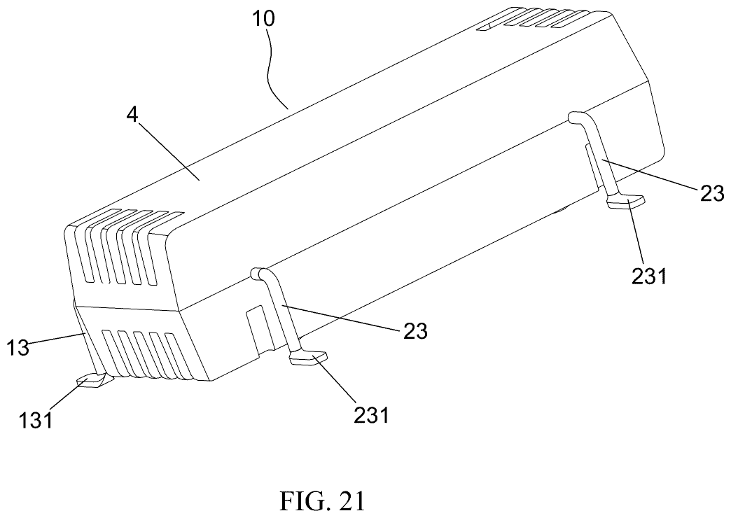

As shown in FIG. 20 and FIG. 21, a reed relay according to a sixth embodiment of the present disclosure differs from that of the fourth embodiment in that: the flat portion 131 is located outside the housing 4, and the contact reed leading-out pins 13 of the reed relay 10 are fitted with the upper end of the PCB 20 by using the flat portion 131 to form an electrical connection. Meanwhile, the two coil leading-out pins 23 are also correspondingly provided with flat portions 231 and fitted with the upper end of the PCB 20 to form an electrical connection, which is convenient for a fitting installation. In Embodiment 6, there is no need to provide any limiting protrusion at the bottom of the housing 4.

### Embodiment 7

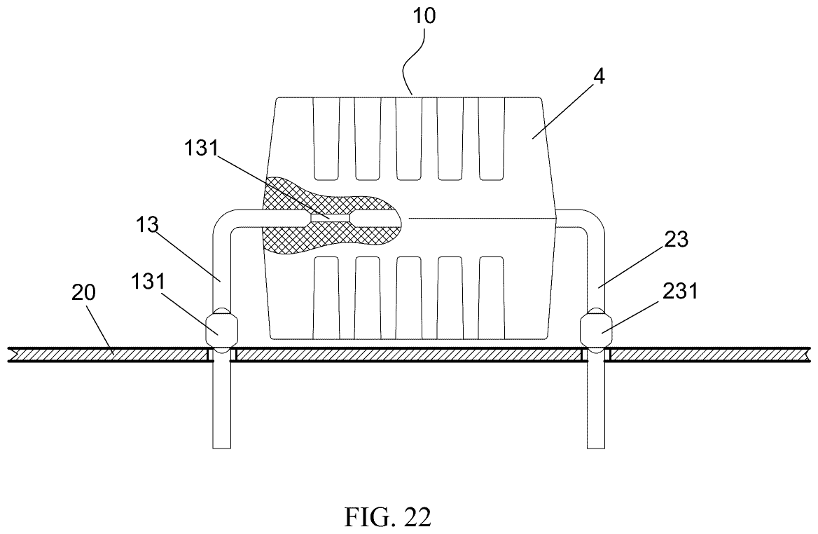

As shown in FIG. 22, a reed relay according to a seventh embodiment of the present disclosure differs from that of the fourth embodiment in that: the two contact reed leading-out pins 13 passing out of the two ends of the bobbin 2 are each provided with two flat portions 131. One flat portion 131 on each contact reed leading-out pin 13 is located inside the housing 4 and combined with the housing 4, while the other flat portion 131 is located outside the housing 4. After the contact reed leading-out pin 13 of the reed relay 10 is connected to the PCB 20, the flat portion 131 located outside the housing 4 abuts against the upper end of the PCB 20 to limit the distance between the bottom of the housing 4 and the PCB 20 and meanwhile, the two coil leading-out pins 23 are also correspondingly provided with flat portions 231 and abut against the upper end of the PCB 20. In Embodiment 7, there is no need to provide any limiting protrusion at the bottom of the housing 4.

### Embodiment 8

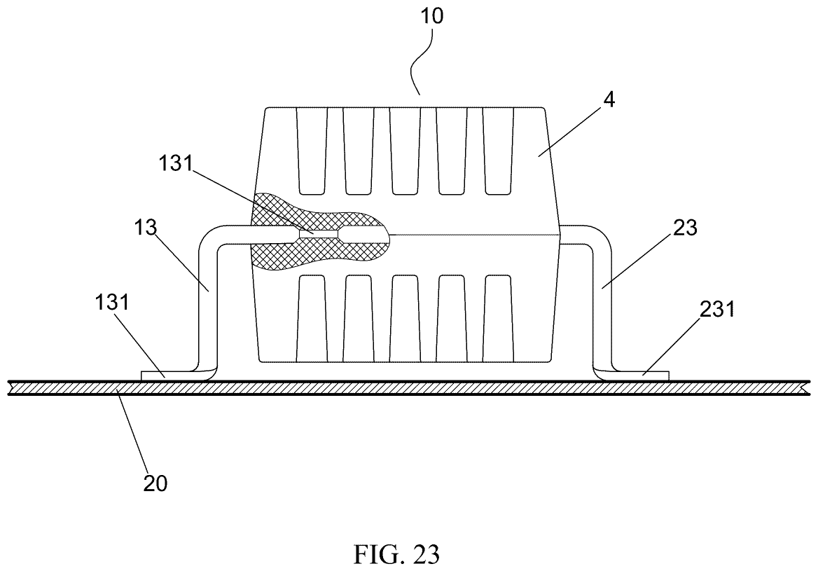

As shown in FIG. 23, a reed relay according to an eighth embodiment of the present disclosure differs from that of the fourth embodiment in that: the two contact reed leading-out pins 13 passing out of the two ends of the bobbin 2 are each provided with two flat portions 131. One flat portion 131 on each contact reed leading-out pin 13 is located inside the housing 4 and combined with the housing 4, while the other flat portion 131 is located outside the housing 4. The contact reed leading-out pins 13 of the reed relay 10 are fitted with the upper end of the PCB 20 by using the flat portion 131 outside the housing 4 to form an electrical connection. Meanwhile, the two coil leading-out pins 23 are also correspondingly provided with flat portions 231 and fitted with the upper end of the PCB 20 to form an electrical connection, which is convenient for a fitting installation. In Embodiment 8, there is no need to provide any limiting protrusion at the bottom of the housing 4.

The present disclosure has the following beneficial effects.
1. The glass tube of the reed switch is covered by plastic, forming an overall rigid connection with the plastic, and avoiding disturbance of the glass tube caused by external vibration, so that a risk of sealing failure due to cracking of the glass tube or destruction of a bonding interface of the sintered section caused by the disturbance is avoided, to ensure the initial sealing performance of the glass tube of the reed switch, and better adapt to application occasions with high requirements for the anti-vibration performance.
2. The contact reed leading-out pin of the reed switch has a part covered and fixed by the head portion of the bobbin, and each sintered section is partially or entirely located in the head portion of one bobbin, so that deformation stress can be prevented from being directly transmitted to a root part of the sintered section of the glass tube during injection molding of the bobbin due to a too small distance between a clamping position of the contact reed leading-out pin and the sintered section of the glass tube, which may cause sealing failure; and the plastic-coated section can be ensured to have certain strength, avoiding a situation that the sintered section of the glass tube is damaged due to mechanical stress transmitted to the root part of the sintered section of the glass tube during reprocessing of the contact reed leading-out pin after injection molding of the bobbin, and enhancing the overall structural strength of the reed switch.
3. By providing each head portion with the coil heat dissipation structure close to the sintered section, the influence that plastic, glass and metal cannot synchronously expand is reduced, and the influence on the initial sealing performance of the glass tube due to extrusion caused by uneven thermal stress is avoided. Meanwhile, the coil heat dissipation structure can increase a creepage distance of the reed relay, and the coil heat dissipation structure is a heat dissipation groove with a weight reduction effect, which reduces the effect of damaging the sealing performance of the glass tube due to flexural deformation of the bobbin caused by a centrifugal effect of high-speed rotation when the coil is wound on the bobbin.
4. The reed relay does not need to adopt glue encapsulation, so that low-molecular-weight substances will not be separated out, which may otherwise degrade insulation performance after connection, and the insulation performance of the reed relay is improved.
5. The bobbin is injection-molded and entirely wraps the glass tube, to facilitate automated production.

In addition, since the glass tube is centrally disposed in the bobbin, the consistency of electrical parameters and the electrical performance can be further improved.

It should be understood that the present disclosure does not limit its application to the detailed structures and arrangements of components presented herein. The present disclosure may have other embodiments and be realized and performed in a variety of ways. The foregoing variations and modifications fall into the scope of the present disclosure. It should be understood that the present disclosure as disclosed and defined in this specification extends to all alternative combinations of two or more individual features mentioned or apparent in the text and/or in the drawings. All of these various combinations constitute a plurality of alternative aspects of the present disclosure. The embodiments described in this specification elaborate the best ways known for realizing the present disclosure and will enable those skilled in the art to utilize the present disclosure.

1. A reed relay, comprising:
a reed switch, comprising a glass tube having a circular tube body; and
a bobbin,
wherein a sintered section is provided at each of two ends of the tube body, two contact reeds capable of contacting or separating from each other are provided inside the tube body, and two contact reed leading-out pins respectively pass out of the two sintered sections along a central axis of the tube body;
the bobbin is injection-molded and entirely wraps the glass tube, the bobbin comprises a winding portion and two head portions connected to two ends of the winding portion, and an end of each of the two contact reed leading-out pins passes out from a central position of an end surface of each of the two head portions;
each sintered section is partially or entirely located in one head portion, a part of each contact reed leading-out pin is covered and fixed by the one head portion, and each head portion is provided with a coil heat dissipation structure close to the sintered section.

2. The reed relay according to claim 1, wherein the two contact reed leading-out pins respectively pass out of the two sintered sections along the central axis of the tube body.

3. The reed relay according to claim 1, wherein a central axis of the head portions of the bobbin coincide with a central axis of the winding portion.

4. The reed relay according to claim 1, wherein the winding portion is in a shape of a circular tubular, a central axis of the circular tubular winding portion coincides with the central axis of the tube body.

5. The reed relay according to claim 1, wherein the coil heat dissipation structure comprises a plurality of heat dissipation grooves on opposite end surfaces of the two head portions, the plurality of heat dissipation grooves are distributed around a cylindrical surface, and a central axis of the cylindrical surface coincides with the central axis of the tube body.

6. The reed relay according to claim 5, wherein each head portion further has a plurality of side surfaces connected to the end surface, one end of each heat dissipation groove extends to the side surfaces of the head portion, and another end of each heat dissipation groove is located on the cylindrical surface.

7. The reed relay according to claim 1, wherein one coil leading-out pin passes through an upper part of each head portion, and an end of each of two coil leading-out pins is electrically connected to a corresponding one of two ends of an enameled wire of the coil.

8. The reed relay according to claim 7, wherein each of the two head portions is provided with a positioning groove, two positioning grooves of the two head portions are located at a same side of the winding portion, another end of each coil leading-out pin is partially located in the positioning groove after being bent.

9. The reed relay according to claim 7, wherein each head portion is provided with a wire passing groove close to an end of the coil leading-out pin; and at least one of the head portions is provided with a winding clamping groove.

10. The reed relay according to claim 1, wherein a shape of a cross-sectional profile of each head portion along a direction perpendicular to the central axis of the tube body comprises a first rectangle and a second rectangle disposed in a middle of an upper surface of the first rectangle, wherein a size of the second rectangle is smaller than a size of the first rectangle in the direction perpendicular to the central axis of the tube body.

11. The reed relay according to claim 1, wherein each contact reed leading-out pin passing out of the head portion is cylindrical, a middle part of each contact reed leading-out pin passing out of the head portion is provided with a flat portion, and the flat portion is parallel to or perpendicular to a contact surface of a contact of the contact reed.

12. The reed relay according to claim 1, wherein an injection molding process portion is provided on one of the two head portions and is located at a central position of the end surface of the head portion away from the winding portion.

13. The reed relay according to claim 2, wherein an injection molding process portion is provided on one of the two head portions and is located at a central position of the end surface of the head portion away from the winding portion.

14. The reed relay according to claim 3, wherein an injection molding process portion is provided on one of the two head portions and is located at a central position of the end surface of the head portion away from the winding portion.

15. The reed relay according to claim 4, wherein an injection molding process portion is provided on one of the two head portions and is located at a central position of the end surface of the head portion away from the winding portion.

16. The reed relay according to claim 5, wherein an injection molding process portion is provided on one of the two head portions and is located at a central position of the end surface of the head portion away from the winding portion.

17. The reed relay according to claim 6, wherein an injection molding process portion is provided on one of the two head portions and is located at a central position of the end surface of the head portion away from the winding portion.

18. The reed relay according to claim 7, wherein an injection molding process portion is provided on one of the two head portions and is located at a central position of the end surface of the head portion away from the winding portion.

19. The reed relay according to claim 8, wherein an injection molding process portion is provided on one of the two head portions and is located at a central position of the end surface of the head portion away from the winding portion.

20. The reed relay according to claim 9, wherein an injection molding process portion is provided on one of the two head portions and is located at a central position of the end surface of the head portion away from the winding portion.
